(19) United States
(12) Patent Application Publication
(10) Pub. No.: US 2008/0262269 A1
(43) Pub. Date: Oct. 23, 2008

(54) Monodonor Phosphonite Ligands

(76) Inventors: Gordon Docherty, Kings Heath (GB); Gary Woodward, Northwich (GB); Martin Wills, Kenilworth (GB); Yingjian Xu, Canley (GB)

Correspondence Address: Jean-Louis Seugnet;Rhodia INC, 8 Cedar Brook Drive, CN 7500, Cranbury, NJ, 08512-7500, US

(21) Appl. No.: 11/631,565

(22) PCT Filed: Jul. 4, 2005
(86) PCT No.: PCT/GB05/02614

§ 371 Date: Apr. 21, 2008

(30) Foreign Application Priority Data
Jul. 5, 2004 (GB) 04149985

(51) Int. Cl. C07F 9/6571

(52) U.S. Cl. 568/12

(57) ABSTRACT

The invention provides the use of a metal complex, which is a complex of one or more metal atoms or ions with one or more ligands, as a catalyst in an organic transformation selected from hydrogenation of carbon-heteroatom double bonds, hydroformylation, dialkylzinc additions to aldehydes, hydrocarboxylation, allylic substitution, oxidation, epoxidation, dihydroxylation, Diels-Alder cycloadditions, dipolar cycloadditions and rearrangement reactions, wherein one or more of the ligands is a ligand of formula (1), wherein the bridge group is an organic functional group, and the R group is a substituted phenyl group, wherein the R group has only one substituent at the ortho position, and wherein a carbon atom of the R group bonds the R group to the P atom. Also provided are monodonor ligands of formula (1) wherein the bridge group is an unsubstituted or substituted binaphthyl group and the R group is a substituted phenyl group, wherein the substituents are selected from halogen, nitro, alkynyl and sulfonic acid groups and unsubstituted or substituted alkyl, aryl, amino and vinyl groups, and wherein the R group has only one substituent at the ortho position, and wherein a carbon atom of the R group bonds the R group to the P atom.

The present invention relates to the use of metal complexes of certain monodonor ligands in catalysing reactions such as hydrogenation reactions of carbon-heteroatom double bonds, and in particular asymmetric hydrogenation of C═O bonds, to new monodonor ligands, to complexes of such ligands, and to processes for producing such ligands and complexes.

For some time it has been known that complexes that contain a diphosphine ligand can act as efficient catalysts for asymmetric reactions. A diphosphine ligand contains two phosphorus atoms, linked by a chain, as shown in general structure A. In a complex with a metal, both phosphines are attached to the metal, as shown in general formula B.

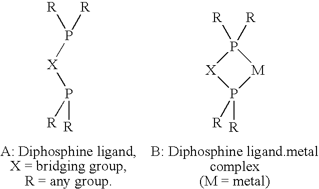

Examples of diphosphine ligands are BINAP, DIOP and DuPHOS.

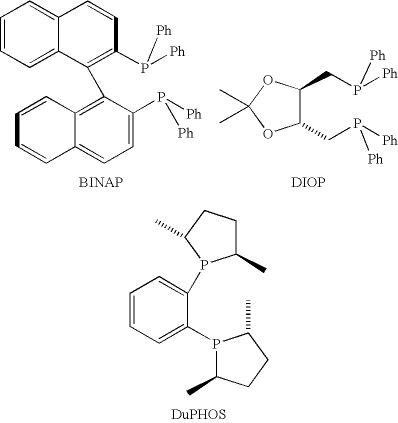

Using complexes of type B, where the metal M is typically Rh or Ru or Ir, certain ketones can be converted to alcohols using asymmetric ketone pressure hydrogenation. However the range of ketones that can be converted in this way is limited to ketones that contain a nearby functional group that can also interact with the catalyst. Ketones lacking this additional group generally fail in this reaction, greatly reducing the value of the reaction.

Some monodonor ligands falling within general structure C, which are usually referred to as BINOL-derived monodonor ligands, have been previously described.

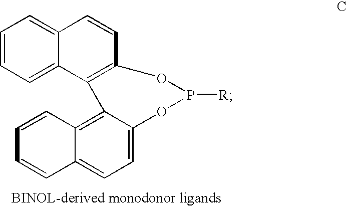

Angewandte Chemie, International Edition (2003), 42(7), 790-793, Tetrahedron Letters (2000), 41(33), 6333-6336, Organic Letters (2003), 5(17), 3099-3101 and Tetrahedron Letters (2002), 43(44), 7941-7943 describe some such ligands with specific R groups that are alkyl, alkoxy, and the like, and the use of rhodium complexes of such ligands to catalyse asymmetric hydrogenation of C═C.

In EP-A-1394168, WO-A-0194278 and WO-A-0204466 some BINOL-derived monodonor ligands of formula C′ have been described for use as catalysts for the hydrogenation of C═O bonds.

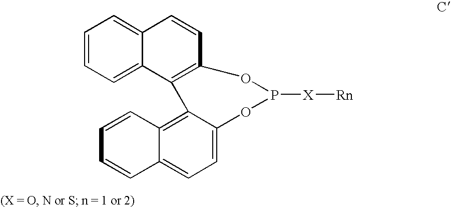

It has recently been described that complexes of ruthenium(II) containing both a diphosphine and a diamine, with general structure D as shown below, are extremely efficient at catalysing the addition of hydrogen to a number of ketones, in high enantiomeric excess (e.e.). As known in the art, this is a measure of selectivity, which is defined as % major enantiomer minus % minor enantiomer; a perfect reaction proceeds in 100% e.e., whilst in practice an e.e of >80%, preferably >90% indicates a very practical and useful reaction.

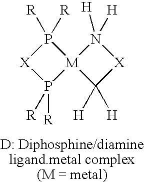

Angew. Chem., Int, Edn., 2001, 40, 40-73, J. Am. Chem. Soc., 2002, 124, 6508-9, Angew. Chem., Int. Edn. Engl., 1998, 37, 1703-7 Org. Lett., 2000, 2, 1749-51, J. Am. Chem. Soc., 2000, 122, 6510-11, and J. Am. Chem. Soc., 1998, 120, 13529-30 all describe such research.

The diamine used in this respect is usually DPEN, as illustrated below, whilst the diphosphine used in this respect is most commonly BINAP. A specific complex using DPEN and BINAP is also shown below, which has two chlorine atoms to balance the charge of the ruthenium atom.

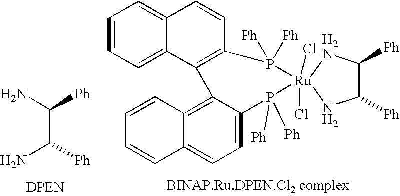

However, this work has only indicated that these useful results can be achieved by metal complexes containing both a diphosphine and a diamine; i.e. two bidentate ligands. The manufacture of bidentate ligands is relatively complex as compared to monodentate ligands.

In the present invention new monodonor ligands have been obtained, and it has been found that these ligands can be used in place of bidentate ligands such as bidentate phosphines to form complexes with metals. These complexes and other similar complexes have proved to have catalytic properties; for example they may be excellent catalysts in the reduction of carbon-heteroatom double bonds, and in particular for asymmetric catalysis. These complexes have been found to be of particular use for the hydrogenation of C═O bonds.

Accordingly, there is provided the use of a metal complex which is a complex of one or more metal atoms or ions with one or more ligands, wherein one or more of the ligands is a ligand of formula (1):

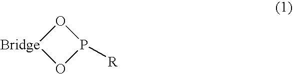

wherein the bridge group is an organic functional group, and the R group is an organic functional group, and wherein a carbon atom of the R group bonds the R group to the P atom;
   as a catalyst in an organic transformation selected from hydrogenation of carbon-heteroatom double bonds, hydroformylation, C—C bond formation, conjugate addition reaction, dialkylzinc additions to aldehydes, hydrocarboxylation, allylic substitution, oxidation, epoxidation, dihydroxylation, Diels-Alder cycloadditions, dipolar cycloadditions and rearrangement reactions.

Specifically, the present invention provides, in a first aspect, the use of a metal complex which is a complex of one or more metal atoms or ions with one or more ligands, wherein one or more of the ligands is a ligand of formula (1):

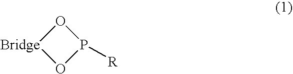

wherein the bridge group is an organic functional group, and the R group is a substituted phenyl group, wherein the R group has only one substituent at the ortho position, and wherein a carbon atom of the R group bonds the R group to the P atom;
   as a catalyst in an organic transformation selected from hydrogenation of carbon-heteroatom double bonds, hydroformylation, dialkylzinc additions to aldehydes, hydrocarboxylation, allylic substitution, oxidation, epoxidation, dihydroxylation, Diels-Alder cycloadditions, dipolar cycloadditions and rearrangement reactions.

Preferably, the use is in the hydrogenation of carbon-heteroatom double bonds, such as the asymmetric hydrogenation of carbon-heteroatom double bonds. The use may, alternatively, be in the symmetric hydrogenation of carbon-heteroatom double bonds. The carbon-heteroatom double bonds are preferably selected from C═O bonds, C═S bonds and C═N bonds. More preferably, the use is in the hydrogenation of C═O bonds, most preferably the asymmetric hydrogenation of C═O bonds.

The R group is a substituted phenyl group in which there is only one substituent at the ortho position. In other words, there is one substituent at the ortho position but there is not more than one substituent at the ortho position. There may or may not be any substituents at the meta and para positions. For example, there may be none, one or two substituents at the meta position and there may be none, one or two substituents at the para position.

The R group may, in one embodiment, contain from 6 to 20 carbon atoms, for example from 6 to 12 carbon atoms, such as from 6 to 10 carbon atoms.

Overall, the R group may have one or it may have more than one substituent group, for example it may have two or more substituent groups or three or more substituent groups. In one embodiment, the R group has only one substituent group.

When there is more than one substituent group, these substituent groups may be the same or different to each other.

The substituent group(s) can be any functional group, such a halogen or organic functional group; the substituent group(s) may preferably be selected from halogen, alkoxy, nitro, alkynyl and sulfonic acid groups and unsubstituted or substituted alkyl, aryl, amino and vinyl groups. It is preferred that the substituent group(s) are groups that contain up to 20 carbon atoms, for example up to 12 carbon atoms, such as 0, 1, 2, 3 or 4 carbon atoms.

The R group substituent(s) may preferably be selected from: halogen groups, for example chlorine, bromine and iodine; C₁₋₁₂ alkyl groups, such as C₁₋₄ alkyl, for example methyl, ethyl, n-propyl, isopropyl and t-butyl groups; alkoxy groups, such as C₁₋₄ alkoxy groups, for example methoxy and ethoxy; and tertiary amino groups, such as tertiary amino wherein the substituent groups of the amine are, independently, selected from C₁₋₄ alkyl, for example dimethylamine and diethylamine. The substituent group(s) may be chosen to be of a size so as to cause steric hindrance to the rotation of the aromatic ring; for example the substituent group(s) may be selected from bromo, iodo, isopropyl, t-butyl, methoxy, ethoxy, dimethylamine and diethylamine.

In one embodiment, the R group is a substituted phenyl group, in which there is only one substituent at the ortho position and no substituents at the meta and para positions.

In an alternative embodiment, there may be one or more substituent at the meta position and there may or may not be any substituents at the para position. In another alternative embodiment there may be one or more substituent at the para position and there may or may not be any substituents at the meta position.

The bridge group may suitably be a substituted or unsubstituted alkyl or aromatic group. The alkyl group may be saturated or unsaturated. The aromatic group may have a single aromatic ring or may have two or more aromatic rings. When the aromatic group has two or more aromatic rings, all of the aromatic rings may be individual aromatic rings, all of the aromatic rings may form one or more series of linked aromatic rings, or it may be that some of the aromatic rings form one or more series of linked aromatic rings whilst some of the aromatic rings are individual aromatic rings.

Preferably, the bridge group is a substituted or unsubstituted aryl group, which may be a single aryl group or may be biaryl or polyaryl.

The bridge group may contain any number of carbon atoms but may, for example, contain from 1 to 30 carbon atoms, such as from 6 to 20 carbon atoms. One or more C atoms in the bridge group may be substituted with another atom; preferably an atom selected from O, N, S, P and metal atoms. Accordingly, the bridge group may, for example, be a heteroaryl group. When one or more C atoms in the bridge group are substituted with a metal atom, the metal atom is preferably a transition metal atom (i.e. a Group 3 to 12 element), such as a Group 6 or Group 8 transition metal, for example Fe, Ru or Cr. Accordingly, the bridge group may, in one embodiment, be an organometallic group.

When the aromatic or alkyl bridge group is substituted, it may have one or more substituent groups. When there is more than one substituent group these substituent groups may be the same or different to each other. The substituent groups may be any functional groups but are preferably selected from halogen, alkoxy, nitro, alkynyl and sulfonic acid groups and unsubstituted or substituted alkyl, aryl, amino and vinyl groups. It is preferred that the substituent groups are groups that contain up to 20 carbon atoms, for example up to 12 carbon atoms, such as 0, 1, 2, 3 or 4 carbon atoms.

In one embodiment, the bridge group is selected from:
—(CH₂)ₙ—, where n is an integer from 1 to 12;
—(CH₂)ₙY(CH₂)ₘ—, where n and m are each integers, which may be the same or different, and are from 1 to 12, and Y is any atom or functional group, such as an organic functional group; preferably Y is selected from O, S, NR′, PR′, AsR′, SbR₂′, divalent aryl and divalent fused aryl divalent heterocyclic, wherein R′ is substituted or unsubstituted aryl or alkyl, such as C₁₋₂ aryl or alkyl;
aromatic groups having from 6 to 20 carbon atoms, such as 1,2-divalent phenyl, 2,2′-biaryl, for example 2, 2′-binaphthyl or 2,2′-biphenyl, or ferrocene, each of which may optionally be substituted with aryl, C₁-C₁₂ alkyl, F, Cl, Br, I, CO₂R″, SO₃R″, PO₃R″₂, OR″, SR″, NR″₂, PR″₂, AsR″₂ or SbR″₂, wherein R″ is H, or is substituted or unsubstituted alkyl or aryl, such as C₁₋₁₂ aryl or alkyl.

Preferably, the bridge group is a substituted or unsubstituted biaryl system, such as a substituted or unsubstituted biphenyl, binaphthyl or bianthracene system. Most preferably the bridge group is a substituted or unsubstituted binaphthyl system. Binaphthyl is of course two naphthyl groups joined together directly with no intervening atoms.

Specific examples of the ligand of formula (1) that may be used are:

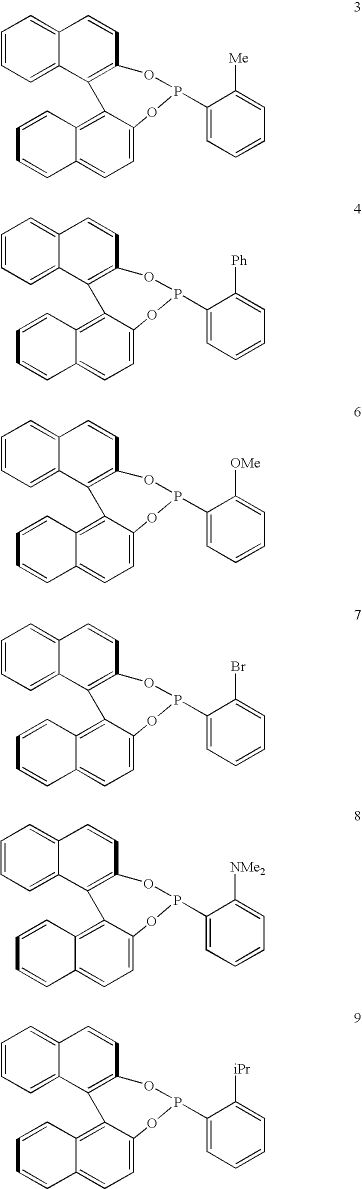

In one embodiment, the ligand of formula (1) is in accordance with the second aspect defined below.

Preferably, the metal complex is a complex of one metal atom or ion with one or more ligands.

The metal may be any metal atom or ion but preferably is a transition metal atom or ion, more preferably a Group 8, 9 or 10 transition metal atom or ion, most preferably a ruthenium, iridium or rhodium atom or ion, for example ruthenium (II).

The metal complex may suitably include one or more ligands that are not ligands in accordance with formula (1). The complex may include one or more ligands selected from: monodonor ligands that are not in accordance with formula (1), bidentate ligands and polydentate ligands. Preferably, the complex may include a bidentate ligand, for example the complex may include a diamine ligand or a diphosphine ligand, such as DPEN or BINAP.

Preferably, the complex includes two or more ligands in accordance with formula (1). These ligands in accordance with formula (1) may be the same or different.

The metal complex is suitably of formula (10):

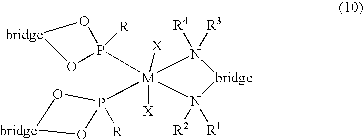

Each bridge group in formula (10) is in accordance with the definitions given above. Each of the bridge groups may be the same or different as each of the other bridge groups; i.e. all of the bridge groups may be identical; all of the bridge groups may be different; the bridge groups on the two monodonor ligands of formula (1) may be the same but the bridge group on the diamine ligand may be different; or the bridge groups on the two monodonor ligands of formula (1) may be different but the bridge group on the diamine ligand may be the same as one of the bridge groups on the two monodonor ligands of formula (1).

Each R group in formula (10) is in accordance with the definitions given above. The R groups may be the same or different.

The groups R¹ to R⁴ are each functional groups, and are preferably selected from hydrogen, hydroxy and thiol and unsubstituted and substituted aryl, alkyl, alkylaryl, aryl alkyl, heterocyclic, dialkylamino, dialkyl, diarylamino, aryloxy, carboxylic acid, alkoxy and alkylthio groups. The groups R¹ to R⁴ may, in one embodiment, contain from 1 to 20 carbon atoms, for example from 2 to 12 carbon atoms, such as from 6 to 10 carbon atoms.

When any of the R¹ to R⁴ groups is substituted, it may have one or more substituent groups. When there is more than one substituent group these substituent groups may be the same or different to each other. The substituent groups can preferably be selected from halogen, alkoxy, nitro, alkynyl and sulfonic acid groups and unsubstituted or substituted alkyl, aryl, amino and vinyl groups. It is preferred that the substituent groups are groups that contain up to 20 carbon atoms, for example up to 12 carbon atoms, such as 0, 1, 2, 3 or 4 carbon atoms.

Each of groups R¹ to R⁴ may be the same or different as each of the other groups R¹ to R⁴; for example all of the groups R¹ to R⁴ may be identical or all of the groups R¹ to R⁴ may be different.

The groups X may or may not be present; when present they may be the same or different and are each any functional group. Preferably each X is selected from hydrogen and a halogen group, such as F, Cl, or Br. Groups X are primarily intended to act as counterions.

Overall the complex may be neutral or may be positively or negatively charged.

In one embodiment there is provided the use of a complex as defined above in the asymmetric hydrogenation of ketones to give alcohols. This reaction is illustrated in the reaction scheme below. In this case the complex is preferably a ruthenium complex, such as a ruthenium (II) complex.

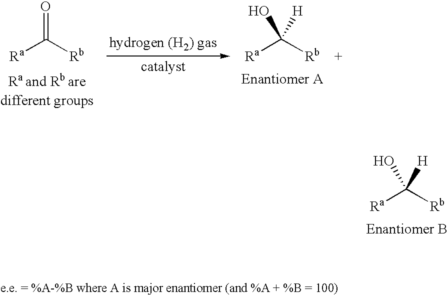

In this reaction the groups R^{a} and R^{b} are not the same and are each functional groups. Preferably, the R^{a} and R^{b} groups are selected from unsubstituted and substituted aryl, alkyl, alkylaryl, aryl alkyl, heterocyclic, carboxylic acid, alkoxy, alkylthio, dialkylamino, dialkyl, diarylamino, and aryloxy groups, and hydroxy and thiol groups. The groups R^{a} and R^{b} may, in one embodiment, each contain from 1 to 20 carbon atoms, for example from 2 to 12 carbon atoms, such as from 6 to 10 carbon atoms.

In one embodiment, the R^{a} and R^{b} groups are independently selected from unsubstituted and substituted aryl and alkyl groups. For example, one of R^{a} and R^{b} may be unsubstituted or substituted aryl, such as unsubstituted or substituted phenyl, whilst the other of R^{a} and R^{b} may be unsubstituted or substituted alkyl, such as unsubstituted or substituted C₁₋₄ alkyl.

When the R^{a} or R^{b} group is substituted, it may have one or more substituent groups. When there is more than one substituent group these substituent groups may be the same or different to each other. The substituent groups can preferably be selected from halogen, alkoxy, nitro, alkynyl and sulfonic acid groups and unsubstituted or substituted alkyl, aryl, amino and vinyl groups. It is preferred that the substituent groups are groups that contain up to 20 carbon atoms, for example up to 12 carbon atoms, such as 0, 1, 2, 3 or 4 carbon atoms.

In one embodiment, the complex is used in the asymmetric hydrogenation of substituted or unsubstituted acetophenone or acetonaphthone. For example, a complex of formula (10) where M is Ru, both X groups are Cl, and the bidentate ligand is DPEN, may be used in the asymmetric hydrogenation of acetophenone. This reaction is illustrated in the reaction scheme below.

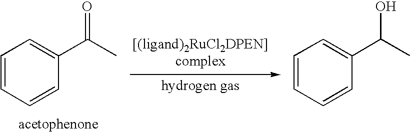

Specific examples of complexes that can be used in the first aspect of the present invention, 11 to 16, are shown below.

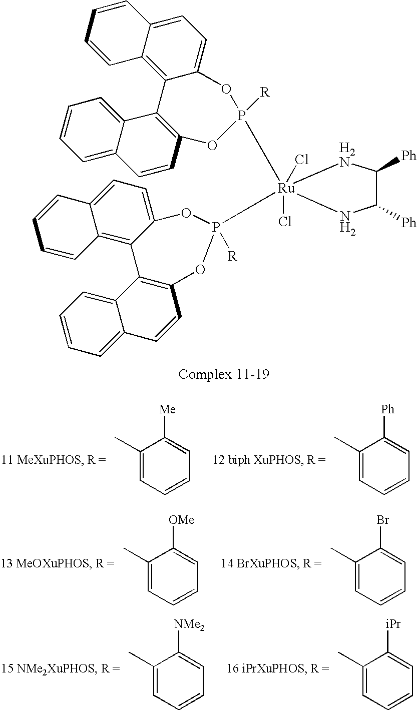

In the use in accordance with the first aspect, the complex may be formed and isolated prior to its use in catalysing the reaction or may be formed and then used to catalyse the reaction in unisolated form. In particular, the complex may be formed by combining the various reactants required to produce the complex immediately before carrying out the reaction to be catalysed.

The complex may be used in asymmetric or racemic form. The selection of the asymmetric form permits the formation of enantiomerically enriched products whilst the use of the racemic form permits the formation of racemic products.

The invention also provides a method of carrying out an organic transformation selected from hydrogenation of carbon-heteroatom double bonds, hydroformylation, dialkylzinc additions to aldehydes, hydrocarboxylation, allylic substitution, oxidation, epoxidation, dihydroxylation, Diels-Alder cycloadditions, dipolar cycloadditions and rearrangement reactions, wherein the method is catalysed by a metal complex which is a complex of one or more metal atoms or ions with one or more ligands, wherein one or more of the ligands is a ligand of formula (1):

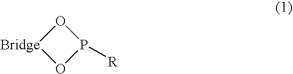

wherein the bridge group is an organic functional group, and the R group is a substituted phenyl group, wherein the R group has only one substituent at the ortho position, and wherein a carbon atom of the R group bonds the R group to the P atom.

The preferred features of said method are the same as the preferred features of the use described above.

Also provided is a monodonor ligand of formula (1):

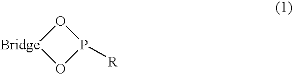

wherein the bridge group is an organic functional group and the R group is an aromatic group with one or more substituent groups, and wherein a carbon atom of the R group bonds the R group to the P atom.

Specifically, the present invention provides, in a second aspect, a monodonor ligand of formula (1):

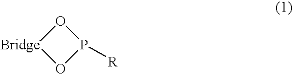

wherein the bridge group is an unsubstituted or substituted binaphthyl group and the R group is a substituted phenyl group, wherein the substituents are selected from halogen, nitro, alkynyl and sulfonic acid groups and unsubstituted or substituted alkyl, aryl, amino and vinyl groups, and wherein the R group has only one substituent at the ortho position; and wherein a carbon atom of the R group bonds the R group to the P atom.

The R group may have one or may have more than one substituent groups, for example two or more substituent groups or three or more substituent groups. In one embodiment, the R group has only one substituent group.

When there is more than one substituent group these substituent groups may be the same or different to each other.

The substituent group(s) can be halogen, nitro, alkynyl or sulfonic acid groups or unsubstituted or substituted alkyl, aryl, amino or vinyl groups. It is preferred that the substituent group(s) are groups that contain up to 20 carbon atoms, for example up to 12 carbon atoms, such as 0, 1, 2, 3 or 4 carbon atoms. It is most preferred that the substituent group(s) are halogen, alkyl, aryl, or amino groups.

In one embodiment, the substituent group(s) are halogen, tertiary amino (such as tertiary amino wherein the substituent groups of the amine are, independently, selected from C₁₋₄ alkyl), or C₁₋₁₂ alkyl (such as C₁₋₄ alkyl). The substituent group(s) may, for example, be iodo, bromo, chloro, fluoro, dimethylamine, diethylamine, methyl, ethyl, n-propyl, isopropyl or t-butyl. The substituent group(s) may be chosen to be of a size so as to cause steric hindrance to the rotation of the aromatic ring; for example the substituent group(s) may be selected from bromo, iodo, isopropyl, t-butyl, dimethylamine and diethylamine.

The R group is a substituted phenyl, in which there is only one substituent at the ortho position. In other words, there is one substituent at the ortho position but there is not more than one substituent at the ortho position. There may or may not be any substituents at the meta and para positions. For example, there may be none, one or two substituents at the meta position and there may be none, one or two substituents at the para position.

In one embodiment, the R group is a substituted phenyl, in which there is only one substituent at the ortho position and no substituents at the meta and para positions.

In an alternative embodiment, there may be one or more substituent at the meta position and there may or may not be any substituents at the sara position. In another alternative embodiment there may be one or more substituent at the para position and there may or may not be any substituents at the meta position.

The bridge group is a substituted or unsubstituted binaphthyl system. Binaphthyl is of course two naphthyl groups joined together directly with no intervening atoms.

The bridge group may contain any suitable number of carbon atoms but may, for example, contain from 20 to 30 carbon atoms, such as from 20 to 25 carbon atoms.

When the bridge group is substituted, it may have one or more substituent groups. When there is more than one substituent group these substituent groups may be the same or different to each other. The substituent groups may be any functional groups but are preferably selected from halogen, alkoxy, nitro, alkynyl and sulfonic acid groups and unsubstituted or substituted alkyl, aryl, amino and vinyl groups. It is preferred that the substituent groups are groups that contain up to 20 carbon atoms, for example up to 12 carbon atoms, such as 0, 1, 2, 3 or 4 carbon atoms.

Specific examples of the ligand are structures 3, 4, 7, 8 and 9 shown below.

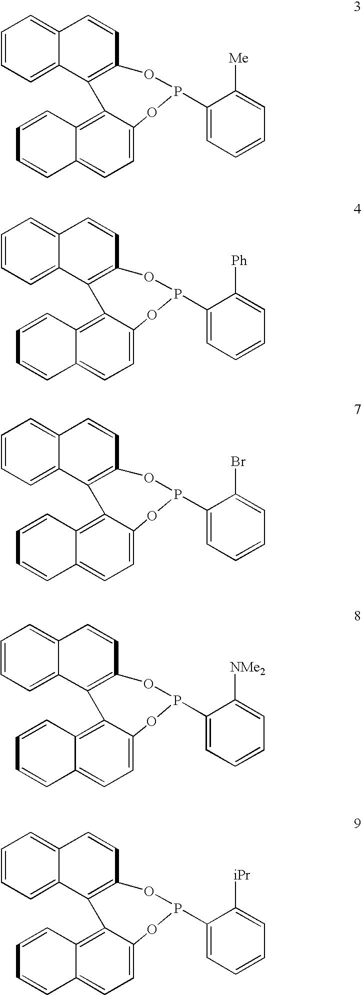

Also provided, in a third aspect, is a metal complex which is a complex of one or more metal atoms or ions with one or more ligands, wherein one or more of the ligands is a ligand in accordance with the second aspect.

Preferably, the metal complex is a complex of one metal atom or ion with one or more ligands in accordance with the second aspect.

The metal may be any metal atom or ion but preferably is a transition metal atom or ion, more preferably a Group 8, 9 or 10 transition metal atom or ion, most preferably a ruthenium, iridium or rhodium atom or ion, for example ruthenium (II).

The metal complex may suitably include one or more ligands that are not ligands in accordance with the second aspect. The complex may include one or more ligands selected from monodonor ligands that are not in accordance with the second aspect, bidentate ligands and polydentate ligands. Preferably, the complex may include a bidentate ligand, for example the complex may include a diamine ligand or a diphosphine ligand, such as DPEN or BINAP.

Preferably, the complex includes two or more ligands in accordance with the second aspect. These ligands in accordance with the second aspect may be the same or different.

Preferably, the metal complex is an organometallic catalyst.

The metal complex is suitably of formula (10):

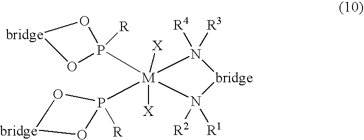

Each bridge group is in accordance with the definitions given above in relation to the ligand of the second aspect. Each of the bridge groups may be the same or different as each of the other bridge groups; i.e. all of the bridge groups may be identical; all of the bridge groups may be different; the bridge groups on the two monodonor ligands of the second aspect may be the same but the bridge group on the diamine ligand may be different; or the bridge groups on the two monodonor ligands of the second aspect may be different but the bridge group on the diamine ligand may be the same as one of the bridge groups on the two monodonor ligands of the second aspect.

Each R group in formula (10) is in accordance with the definitions given above in relation to the ligand of the second aspect. The R groups may be the same or different.

The groups R¹ to R⁴ are functional groups and are preferably selected from hydrogen, hydroxy and thiol and unsubstituted and substituted aryl, alkyl, alkylaryl, aryl alkyl, heterocyclic, dialkylamino, dialkyl, diarylamino, aryloxy, carboxylic acid, alkoxy and alkylthio groups. The groups R¹ to R⁴ may, in one embodiment, contain from 1 to 20 carbon atoms, for example from 2 to 12 carbon atoms, such as from 6 to 10 carbon atoms.

When any of the R¹ to R⁴ groups is substituted, it may have one or more substituent groups. When there is more than one substituent group these substituent groups may be the same or different to each other. The substituent groups can preferably be selected from halogen, alkoxy, nitro, alkynyl and sulfonic acid groups and unsubstituted or substituted alkyl, aryl, amino and vinyl groups. It is preferred that the substituent groups are groups that contain up to 20 carbon atoms, for example up to 12 carbon atoms, such as 0, 1, 2, 3 or 4 carbon atoms.

Each of groups R¹ to R⁴ may be the same or different as each of the other groups R¹ to R⁴; for example all of the groups R¹ to R⁴ may be identical or all of the groups R¹ to R⁴ may be different.

The groups X may or may not be present; when present they may be the same or different and may each be any functional group. Preferably each X is selected from hydrogen and a halogen group, such as F, Cl, or Br. Groups X are primarily intended to act as counterions.

Overall the complex may be neutral or may be positively or negatively charged.

Examples of complexes in accordance with the third aspect of the invention, 11, 12, 14, 15, and 16 are shown below.

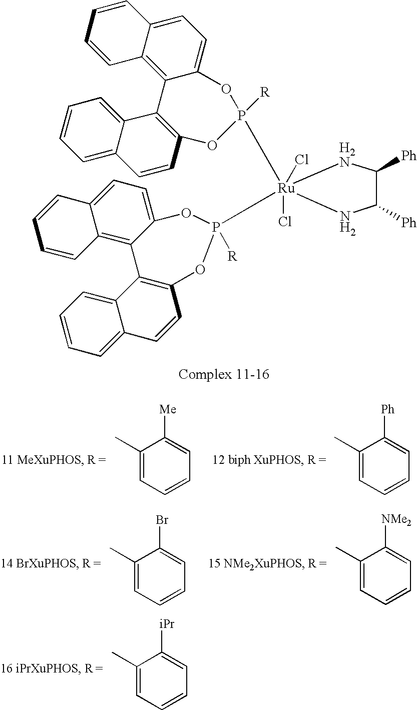

The present invention also provides, in a fourth aspect, a process for the production of a complex in accordance with the third aspect, the process comprising reacting one or more ligand molecules in accordance with the second aspect with a source of metal salt.

When the complex in accordance with the third aspect that is being produced has X groups, the source of metal salt may also provide the X groups. Alternatively, the X groups may be provided by an additional reactant.

Preferably, the process comprises reacting two ligand molecules in accordance with the second aspect with a source of metal salt.

More preferably, the process comprises reacting two ligand molecules in accordance with the second aspect with a source of metal salt and one equivalent of a bidentate ligand, preferably a diamine.

The diamine is suitably of formula R¹R²N-bridge-NR³R⁴, wherein the bridge group and groups R¹, R², R³ and R⁴ are as defined above in relation to the complex of the third aspect. The diamine may be DPEN.

The present invention also provides, in a fifth aspect, a process for the production of a ligand in accordance with the second aspect, the process comprising:
(a) combining, in a solvent, a diol with
   (i) a bis(dialkylamino)alkylphosphine; or
   (ii) a bis(dialkylamino)arylphosphine; or
   (iii) a dichloroalkylphosphine and a base; or
   (iv) a dichloroarylphosphine and a base;
   to give a mixture;
(b) heating the mixture; and
(c) removing the solvent to furnish a ligand in accordance with the second aspect;
   wherein the diol is such that it provides the bridge group of the ligand of the second aspect and wherein the alkylphosphine or arylphosphine of component (i), (ii), (iii), or (iv) is such that it provides the R group of the ligand of the second aspect.

In step (b) the heating is suitably carried out until most or all of the dialkylamine or dichloro has been replaced by the diol. Accordingly the length of this step will depend upon the reactants and the reaction conditions. However, suitably, step (b) may be carried out for from 10 hours to 48 hours, for example from 18 hours to 30 hours, such as for 24 hours. In step (b) the mixture may be heated to any suitable temperature but may preferably be heated up to reflux.

The progress of the reaction may suitably be monitored during step (b); for example by using NMR such as ³¹P NMR.

Prior to carrying out step (b), the mixture may be stirred. For example, prior to carrying out step (b), the mixture may be stirred at room temperature. This stirring may be carried out for any suitable length of time; for example from 2 minutes to 20 minutes, such as from 5 minutes to 10 minutes.

The base, when present, may be any suitable base, for example, triethylamine.

The diol may be any suitable diol in view of the intended bridge group but may, for example, be (R) or (S) BINOL.

The components (i), (ii), (iii), or (iv) may be any suitable phosphine in view of the intended R but component (ii) may, for example, be bis(diethylamino)phenylphosphine or may be bis(dimethylamino)phosphinobromobenzene.

The solvent used in step (a) may be an organic solvent; for example, toluene.

The present invention will now be further described by reference to the following Examples, which are not intended to be limiting on the scope of the invention.

### EXAMPLES

### 1. Preparation of Ligands

### 1.1 Synthesis of (S)—BrXuPHOS (Ligand 7)

To a solution of ortho-bis(dimethylamino)phosphinobromobenzene (0.822 g, 0.003 mol) dissolved in toluene (25 ml) was charged a solution of (S)-bi-2-naphthol (0.859 g, 0.003 mol) in toluene (25 ml). The reaction flask was placed in an oil bath and was stirred at room temperature for 10 mins, and then was heated up to reflux for 24 h. The reaction was monitored by ³¹P NMR, and the released dimethylamine gas was monitored by pH paper.

After the reaction finished, the reaction product was allowed to cool down to room temperature. Solvent was removed to leave a yellow oil. 30 ml of degassed pentane was charged into the oil above and stirred overnight. The resulting suspension was filtered and rinsed with further pentane. The off white solid was left to dry under high vacuum.

The solid was purified by recrystallization with toluene to give slightly yellow crystals (1.17 g, 82%). mp 225-27° C.; [α]_{D}²⁷=+46.0 (c 0.2, CH₂Cl₂); IR: νₘₐₓ solid/cm⁻¹=3053, 1226, 1199, 948, 821, 803, 749; ¹H NMR (300 MHz, CDCl₃) δ=8.05-8.02 (2H, m, Ar—H), 7.82-7.80 (1H, d, Ar—H), 7.62-7.59 (3H, m, Ar—H), 7.47-7.18 (8H, m, Ar—H), 7.03-6.96 (1H, m, Ar—H), 6.82-6.78 (1H, m, Ar—H); ¹³C NMR (75 MHz, CDCl₃) δ=149.99 (s), 149.20 (s), 133.35 (s), 133.17 (d, J_{CP} 5.75 Hz), 132.8 (s), 132.1 (s), 131.9 (d, J_{CP} 4.60 Hz), 131.1 (s), 129.87 (s), 128.8 (d, J_{CP} 8.62 Hz), 128.2 (s), 127.2 (d, J_{CP} 5.17 Hz), 126.7 (s), 126.5 (s), 125.5 (s), 125.2 (s), 121.9 (d, J_{CP} 5.75 Hz); ³¹P NMR (162 MHz, CDCl₃) δ=174.7.

### 2. Preparation of Complexes

2.1 Synthesis of (S, S, SS) Ru—Br XuPHOS (complex 14)

[RuCl₂(C₆H₆)]₂ (100 mg, 0.200 mmol) and (S)—Br XuPHOS 7 (377 mg, 0.800 mmol, 4e.q.) were placed in a 50-ml schlenk flask. After the air in the flask was replaced with argon, anhydrous DMF (10 ml) was added, the mixture was degassed and stirred under argon at 100° C. for 10 min to form a reddish brown solution. After the solution was cooled to 25° C., (S, S)-DPEN (85 mg, 0.400 mmol) was added and the mixture was degassed again before it was stirred for 3 h.

After the reaction finished, the supernatant was removed. DCM was then added several times into the reaction mixture; at each addition the reaction mixture was placed under high vacuum and then placed back under argon.

The resulting dark yellow solid was dried under the high vacuum and recrystalised in hot DMF (100 mg/3.3 ml) at 100° C. to give the final bright golden crystals (S, S, SS) Ru—Br XuPHOS (345 mg, 65%). mp 235-237° C. (dec.); [α]_{D}¹⁹=−496.8 (C 0.1, CH₂Cl₂); IR: νₘₐₓ solid (cm⁻¹)=2927, 2360, 1673, 1224, 954, 809; ¹H NMR (300 MHz, CDCl₃) δ=8.43-8.41 (2H, m, Ar—H), 8.15-8.14 (2H, m, Ar—H), 7.92-7.86 (4H, m, Ar—H), 7.51-7.26 (6H, m, Ar—H), 7.12-7.10 (10H, m, Ar—H), 6.98-6.84 (12H, m, Ar—H), 6.55-6.30 (6H, m, Ar—H), 4.55-4.53 (2H, m, 2NHH), 4.23-4.20 (2H, m, 2NHH), 2.88-2.83 (2H, m, 2CH); ³¹P NMR (162 MHz, CDCl₃) δ=203.9; LSIMS: m/z (FAB)=1291 ([M-Cl]⁺, 55%), 219 (65%), 154 (100%); HRMS: calc for C₆₆H₄₈Br₂Cl₂N₂O₄P₂Ru: 1291.0168 ([M-Cl]⁺). Found 1291.0167.

### 3. Catalysed Asymmetric Hydrogenation Reaction

### 3.1 General Experimental Procedure for Asymmetric Hydrogenation of Acetophenone Catalysed by (S, S, SS) BrXuPHOS₂.RuCl₂.DPEN Complex

In an oven dried round bottom flask (250 mL), acetophenone (2.10 mL, 2.17 g, 18.08 mmol) and (CH₃)₃COK (10 mg, 0.0904 mmol, 0.5 mol %) were dissolved in dry and degassed 2-propanol (120 mL). (S, S, SS) Ru—BrXuPHOS complex 14 (12 mg, 0.00904 mmol, 0.05 mol %) was dissolved in dry and degassed CH₂Cl₂ (6 mL), which was used as the catalyst stock solution and was transferred into the reaction solution above under argon. The mixture was degassed by three vacuum-filling with argon cycles and then it was quickly transferred into the autoclave. It was purged with hydrogen for 10 seconds at 2, 5 and 8 atm respectively, and finally the hydrogen was introduced to 10 atm.

The reaction mixture was stirred vigorously at 20-22° C. for 20 h. The mixture was filtered through a pad of silica gel and the pad was washed with a 50% solution of ethyl acetate in hexane (150 mL). The filtrate was concentrated under reduced pressure to afford the reduction product.

### 3.2 Asymmetric Hydrogenation of Acetophenone Catalysed by Complexes

A number of different complexes were used to catalyse asymmetric hydrogenation of acetophenone in accordance with the above general procedure.

Most reactions were carried out at 20-22 degrees C., 10 atm pressure hydrogen, 1 mol % base, ketone concentration 0.3M and with a substrate:catalyst:base ratio of 1000:1:10.

The exceptions were: run 1-H, where a 2000:1:10 substrate:catalyst:base ratio was used, with 0.5 mol % base, and a 50 atm pressure was used; and run 1-I, where a 10000:1:10 substrate:catalyst:base ratio was used, with 0.5 mol % base, and a 50 atm pressure was used.

The results are shown in Table 1 below.

TABLE 1
Reduction of acetophenone

| Run | Catalyst | Time | Conv | e.e. |
|---|---|---|---|---|
| 1-A | (S,S,SS) Ru-Me XuPHOS | 20 h | trace | N/A |
| | (11) | | | |
| 1-B | (R, R, RR) Ru-biPh XuPHOS (12) | 20 h | 5% | 35% (S) |
| 1-C | (S,S,SS) Ru-MeO XuPHOS | 20 h | 54% | 89% (R) |
| | (13) | | | |
| 1-D | (S,S,SS) Ru-MeO XuPHOS | 40 h | 100% | 88% (R) |
| | (13) | | | |
| 1-E | (S,S,SS) Ru—Br XuPHOS | <4 h | 100% | 90.2% (R) |
| | (14) | | | |
| 1-F | (S,S,SS) Ru—Br XuPHOS | 26 h | 80% | 90% (R) |
| | (14) | | | |
| Comp | BINAP•Ru•DPEN•Cl₂ | 100 | 100% | 87%* |

*Taken from review by R. Noyori, Angew. Chem., Int. Edn. Engl., 2001, 40, 40-73.

As can be seen, a number of the complexes were able to give good enantioselectivity, for example an e.e. of 85% or higher, and/or a high conversion, for example a conversion of 80% or more, such as 95% or higher. Indeed, two of the complexes gave an improved result over the comparative example of the known complex containing BINAP.

### 3.3 Asymmetric Hydrogenation of Various Ketones Catalysed by (S, S, SS) Ru—BrXuPHOS

(S, S, SS) Ru—BrXuPHOS (complex 14) was used to catalyse asymmetric hydrogenation of a number of different ketones in accordance with the above general procedure described for acetophenone.

All reactions were carried out at 20-22 degrees C., 10 atm pressure hydrogen, 0.5 mol % base, and with a substrate:catalyst:base ratio of 2000:1:10, for a time of 20 hours.

The results are shown in Table 2 below.

TABLE 2
Reduction of ketones by (S,S,SS) Ru—BrXuPHOS

| | | Ketone | | |
|---|---|---|---|---|
| Run | Substrate | Conc. | Conv. | e.e. |
| 2-A | 4′-MeO acetophenone | 0.30 M | 100% | 85.2% (R) |
| 2-B | 4′-Br acetophenone | 0.30 M | 100% | 80.0% (R) |
| 2-C | 2,5′-Dimethoxyacetophenone | 0.30 M | 46% | 28.0% (S) |
| 2-D | 4′-Fluoroacetophenone | 0.30 M | 98.2% | 93.5% (R) |
| 2-E | 2′-acetonaphthone | 0.30 M | 86% | 82.5% (R) |
| 2-F | 2′-acetonaphthone | 0.15 M | 98.6% | 85.0% (R) |
| 2-G | 3′-trifluoromethylacetophenone | 0.30 M | 36.2% | 77.0% (R) |
| 2-H | 1′-acetonaphthone | 0.15 M | 93.1% | 94.2% (R) |
| 2-I | 2′-bromoacetophenone | 0.15 M | 100% | 91.0% (R) |
| 2-J | 4′-methylacetophenone | 0.15 M | 97.4% | 95.6% (R) |
| 2-K | 3′-methylacetophenone | 0.15 M | 100% | 86.3% (R) |
| 2-L | 4′-trifluoromethylacetophenone | 0.15 M | 100% | 75% (R) |

### 3.4 Asymmetric Hydrogenation of Various Ketones Catalysed by (S, S, SS) Ru-MeOXuPHOS

(S, S, SS) Ru-MeOXuPHOS (complex 13) was used to catalyse asymmetric hydrogenation of a number of different ketones in accordance with the above general procedure described for acetophenone.

All reactions were carried out at 20-22 degrees C., 10 atm pressure hydrogen, 1 mol % base, and with a substrate:catalyst:base ratio of 1000:1:10.

The results are shown in Table 3 below.

TABLE 3
Reduction of ketones by (S,S,SS) Ru-MeOXuPHOS

| | | Ketone | | | | |
|---|---|---|---|---|---|---|
| Run | Substrate | Conc. | Pressure | Time | Conv. | e.e. |
| 3-A | Acetophenone | 0.30 M | 10 atm | 40 h | 100% | 88% (R) |
| 3-B | 4′-methylacto- | 0.15 M | 20 atm | 20 h | 100% | 94% (R) |
| | phenone | | | | | |
| 3-C | 1′-aceto- | 0.15 M | 20 atm | 20 h | 100% | 88% (R) |
| | naphthone | | | | | |
| 3-D | 4′-Fluoroaceto- | 0.15 M | 20 atm | 20 h | 100% | 89% (R) |
| | phenone | | | | | |

3.5 Asymmetric Hydrogenation of Various Ketones Catalysed by (S, S, SS) Ru—BrXuPHOS in an ice bath

(S, S, SS) Ru—BrXuPHOS (complex 14 of the present invention) was used to catalyse asymmetric hydrogenation in an ice bath of a number of different ketones in accordance with the above general procedure described for acetophenone.

All reactions were conducted in an ice bath, in 2-propanol, with 0.5 mol % t-BuOK, and S/C=2000 (autoclave placed in the ice bath) at 50 atm pressure hydrogen, with a 0.15M solution of ketone and with a substrate:catalyst:base ratio of 2000:1:10.

The results are shown in Table 4 below.

TABLE 4
Reduction of ketones by (S,S,SS) Ru—BrXuPHOS

| Run | Substrate | Time | conv. | e.e. |
|---|---|---|---|---|
| 4-A | Acetophenone | 4 h | 95% | 93% (R) |
| 4-B | 1′-acetonaphthone | 8 h | 92% | 99% (R) |
| 4-C | 2′-bromoacetophenone | 8 h | 93% | 99% (R) |

1-48. (canceled)

49. A monodonor ligand of formula (1): 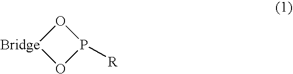
wherein in formula (1) the bridge group is an unsubstituted or substituted binaphthyl group and the R group is a substituted phenyl group, wherein the substituents are halogen, nitro, alkynyl, sulfonic acid, optionally substituted alkyl, aryl, amino or vinyl group, and wherein the R group has only one substituent at the ortho position; and wherein a carbon atom of the R group bonds the R group to the P atom.

50. The ligand according to claim 49, wherein there are no substituents at the meta and para positions on the R group.

51. The ligand according to claim 49, wherein the substituent groups are iodo, bromo, chloro, fluoro, dimethylamine, diethylamine, methyl, ethyl, n-propyl, isopropyl or t-butyl.

52. A metal complex which is a complex of one or more metal atoms or ions with one or more ligands, wherein one or more of the ligands is a ligand as defined in claim 49.

53. The complex according to claim 52 wherein the metal is a Group 8, 9 or 10 transition metal atom or ion.

54. The complex according to claim 53 wherein the metal is a ruthenium, iridium or rhodium atom or ion.

55. The complex according to claim 52 wherein the complex includes two or more ligands as defined in claim 49.

56. The complex according to claim 52 wherein the metal complex is of formula (10): 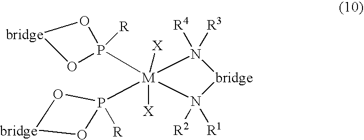
wherein each bridge group and each R group in formula (10) is halogen, nitro, alkynyl, sulfonic acid, optionally substituted alkyl, aryl, amino or vinyl group, and wherein the R group has only one substituent at the ortho position; and wherein a carbon atom of the R group bonds the R group to the P atom, the groups R¹ to R⁴ are each, independently, functional groups, and the groups X are optional and each represents, independently, a functional group.

57. The complex according to claim 56 wherein the groups R¹ to R⁴ are each, independently, hydrogen, hydroxyl, thiol, optionally substituted aryl, alkyl, alkylaryl, aryl alkyl, heterocyclic, dialkylamino, dialkyl, diarylamino, aryloxy, carboxylic acid, alkoxy or alkylthio groups.

58. The complex according to claim 56, wherein each X is, independently, hydrogen or a halogen group.

59. A process for the production of a complex as defined in claim 52, said process comprising the step of reacting one or more ligand molecules as defined in claim 49 with a source of metal salt.

60. The process according to claim 59, wherein the process comprises reacting two ligand molecules with a source of metal salt and one equivalent of a bidentate ligand.

61. The process according to claim 60, wherein the diamine is of formula R¹R²N-bridge-NR¹R⁴ wherein the bridge group is as defined in claim 26 and the groups R¹R², R³ and R⁴ are as defined in claim 36.

62. The process for the production of a ligand according to claim 59, said process comprising the steps of:
(a) combining, in a solvent, a diol with (i) a bis(dialkylamino)alkylphosphine; or (ii) a bis(dialkylamino)arylphosphine; or (iii) a dichloroalkylphosphine and a base; or (iv) a dichloroarylphosphine and a base; to give a mixture;
(b) heating the mixture; and
(e) removing the solvent to furnish said ligand; wherein the diol is such that it provides the bridge group of the ligand and wherein the alkylphosphine or arylphosphine of component (i), (ii), (iii), or (iv) is such that it provides the R group of the ligand.

63. The process according to claim 62, wherein in step (b) the heating is carried out until most or all of the dialkylamine or dichloro has been replaced by the diol.

64. The process for performing on a starting product a reaction of hydrogenation of carbon-heteroatom double bonds, hydroformylation, dialkylzinc additions to aldehydes, hydrocarboxylation, allylic substitution, oxidation, epoxidation, dihydroxylation, Diels-Alder cycloaddition, dipolar cycloaddition or a rearrangement reaction comprising the step of using as a catalyst a metal complex, which is a complex of one or more metal atoms or ions with one or more ligands of formula: 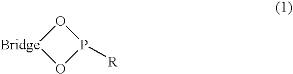
wherein the bridge group is an organic functional group, and the R group is a substituted phenyl group, wherein the R group has only one substituent at the ortho position, and wherein a carbon atom of the R group bonds the R group to the P atom.

65. The process according to claim 64 wherein the reaction is the optionally asymmetric hydrogenation of carbon-heteroatom double bonds.

66. The process according to claim 65 wherein the reaction is the carbon-heteroatom double bonds are C=0 bonds, C═S bonds or C═N bonds.

67. The process according to claim 66 wherein there are no substituents at the meta end para positions of the R group.

68. The process according to claim 64 wherein the R group substituents are selected from halogen groups, C₁₋₁₂ alkyl groups, alkoxy groups or tertiary amino groups.
and the bridge group is an optionally substituted alkyl or aromatic group.

69. The process according to claim 68 wherein the bridge group is: —(CH2)n-, where n is an integer from 1 to 12;
—(CH2), Y(CH2)m-, where n and m are each integers, which are the same or different, and are from 1 to 12, and Y is any atom or functional group; or
aromatic groups having from 6 to 20 carbon atoms, which are optionally substituted with aryl, C₁-C₁₂ alkyl, F, Cl, Br, I, CO₂R″, SO₃R″, PO₃R″₂, OR″, SR″, NR″₂, PR″₂, AsR″₂ or SbR″₂, wherein R″ is H. or an optionally substituted alkyl or aryl.

70. The process according to claim 69, wherein Y is O. S. NR′, PR′, AsR′, SbR2′, divalent aryl, or divalent heterocyclic, wherein R′ is substituted or unsubstituted aryl or alkyl.

71. The process according to claim 69, wherein the aromatic groups having from 6 to 20 carbon atoms are 1,2-divalent phenyl, 2,2′-biaryl, or ferrocene.

72. The process according to claim 69 wherein the metal is a Group 8, 9 or transition metal atom or ion.

73. The process according to claim 72, wherein the metal is a ruthenium, iridium or rhodium atom or ion.

74. The process according to claim 64 wherein the complex comprises two or more ligands according to formula (1).

75. The process according to claim 64 wherein the metal complex is of formula (10): 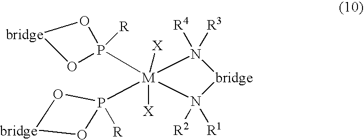
wherein each bridge group and each R group in formula (10) is halogen, nitro, alkynyl, sulfonic acid, optionally substituted alkyl, aryl, amino or vinyl group, and wherein the R group has only one substituent at the ortho position; and wherein a carbon atom of the R group bonds the R group to the P atom, the groups R¹ to R⁴ are each, independently, functional groups, and the groups X may or may not be present; when present they are each, independently, a functional group.

76. The process according to claim 75 wherein the groups R¹ to R⁴ are each, independently, hydrogen, hydroxyl, thiol, optionally substituted aryl, alkyl, alkylaryl, aryl alkyl, heterocyclic, dialkylamino, dialkyl, diarylamino, aryloxy, carboxylic acid, alkoxy or alkylthio groups.

77. The process according to claim 75, wherein each X is, independently, hydrogen or a halogen group.

78. The process according to claim 75 wherein the starting product is a ketone and the reaction is an asymmetric hydrogenation giving alcohols.

79. The process according to claim 78 wherein the ketone is an optionally substituted acetophenone or acetonaphthone.
